(19) United States
(12) Patent Application Publication
(10) Pub. No.: US 2026/0102018 A1
(43) Pub. Date: Apr. 16, 2026

(54) GRIDDLE HAVING CAST ALUMINUM HEAT SINK WITH EMBEDDED HEATING ELEMENT

(71) Applicant: STEARNS PRODUCT DEVELOPMENT CORPORATION, Perris, CA (US)

(72) Inventor: Howard Frantz, Irvine, CA (US)

(21) Appl. No.: 19/351,736

(22) Filed: Oct. 7, 2025

Related U.S. Application Data
(60) Provisional application No. 63/706,603, filed on Oct. 11, 2024.

(51) Int. Cl. A47J 37/06

(52) U.S. Cl. CPC A47J 37/0676

(57) ABSTRACT

A griddle comprises a cast aluminum platen with at least one heating element fully encapsulated therein, a thin steel griddle plate abutting the platen, and a spring-loaded compression assembly configured to maintain tight contact between the platen and plate while accommodating differential thermal expansion. The griddle further includes a plurality of threaded studs, heavy-duty springs, and spring supports, as well as an insulation layer and bottom enclosure to minimize heat loss and protect internal components. The heating element is regulated by a temperature controller, and the griddle may be configured for multiple temperature zones with independent control. The griddle delivers improved thermal conductivity, energy efficiency, temperature consistency, and durability for commercial cooking applications.

### CROSS-REFERENCE TO RELATED APPLICATIONS

This application claims the benefit of U.S. Provisional Application Ser. No. 63/706,603, filed Oct. 11, 2024, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates to commercial cooking appliances, and more specifically to griddles featuring improved heat transfer, temperature control, and durability through the use of cast aluminum heat-sink platens, thin steel griddle plates, and spring-loaded compression assemblies.

### 2. Description of the Related Art

Griddles are a staple in commercial foodservice operations, ranging from fast food establishments to fine dining restaurants. Their primary function is to provide a large, flat cooking surface capable of preparing a variety of foods such as eggs, pancakes, meats, and tortillas. Despite their widespread use, conventional griddle designs exhibit several persistent shortcomings that impact cooking performance, energy efficiency, and equipment longevity.

Traditional griddles typically employ a thick steel plate, often ranging from one-half inch to one inch in thickness, as the primary heat sink and cooking surface. The steel plate is typically heated by electric heating elements or gas burners positioned beneath the plate. Electric griddles commonly utilize round tubular heating elements, sometimes referred to as calrods, or flat bar elements known as firebars. These heating elements may be abutted directly to the underside of the steel plate or placed within grooves machined into the plate to increase surface contact. In addition to electric heating elements, gas heating elements may also be used, which rely on convective or radiant heat from atmospheric tube burners or infrared burners.

A significant limitation of steel as a heat sink is its relatively low thermal conductivity, typically around 45 W/m·K. This property results in uneven heat distribution across the cooking surface, leading to hot and cold spots that can vary by as much as 60° F. Such temperature inconsistencies make it difficult for cooks to achieve uniform results, especially when preparing multiple items simultaneously. The problem may be exacerbated in griddles designed with multiple temperature zones, as heat tends to bleed between zones, creating gradual temperature gradients rather than sharply defined boundaries.

Another drawback of conventional designs is the direct contact between heating elements and the steel plate. While this arrangement facilitates conductive heat transfer, it also exposes the heating elements to high temperatures, often approaching 1,200° F. In areas where the heat element is not in direct contact with the steel plate, the temperature can rise even higher, accelerating the breakdown of dielectric insulation and leading to frequent element failure. This not only increases maintenance costs, but also results in equipment downtime.

Energy efficiency is also compromised in traditional griddles. Because much of the heating element is not in direct contact with the steel plate, a significant portion of the energy consumed is lost to the environment rather than being transferred to the food. This inefficiency manifests as slower heat-up and recovery times, increased energy consumption, and higher operating costs.

Attempts to address these issues have included the use of composite griddle plates, such as those produced by fusing a stainless-steel top to an aluminum base. While these designs offer some improvement in heat distribution, they often rely on metallurgical bonding processes and do not fully resolve the challenges associated with differential thermal expansion, element protection, and zone isolation.

In summary, there remains a need for a griddle that provides improved temperature consistency, enhanced energy efficiency, reduced heating element failure, and sharply defined temperature zones. Various aspects of the present disclosure address this particular need, as will be discussed in more detail below.

### BRIEF SUMMARY

In accordance with one embodiment of the present disclosure, there is provided a griddle designed to overcome the persistent challenges found in conventional commercial griddles. The griddle features a cast aluminum platen that serves as a highly efficient heat sink. This platen is formed with at least one opening and contains a heating element that is fully encapsulated within the aluminum, except for the electrical leads that allow for connection to a power source. By embedding the heating element in the aluminum, the griddle ensures even heat distribution and protects the heating element from reaching excessively high temperatures, thereby reducing the risk of element failure.

Positioned above the cast aluminum platen is a steel griddle plate, which is machined to provide a smooth and level interface with the platen. The steel plate may be notably thin, preferably less than 0.2 inch in thickness, which may allow for rapid and efficient heat transfer from the platen to the cooking surface. This thin steel layer provides the durability and cooking performance required in commercial settings, while the underlying aluminum maximizes thermal conductivity.

To maintain optimal contact between the steel griddle plate and the cast aluminum platen, the griddle may employ a spring-loaded compression assembly. Threaded studs may be welded to the bottom surface of the steel griddle plate and extend through corresponding openings in the cast aluminum platen. Heavy-duty springs, such as coiled compression springs or spring washers, may be disposed on each stud and supported by spring supports, which may include nuts that can be tightened to achieve the desired compression. This assembly may be specifically configured to urge the cast aluminum platen against the steel griddle plate, accommodating differential thermal expansion between the two metals. As a result, the griddle may resist warping and maintain consistent contact for efficient heat transfer, even as temperatures fluctuate during operation.

The griddle may further include an insulation layer disposed below the cast aluminum platen to minimize heat loss. The insulation may include holes or openings corresponding to the location of the studs to allow for easy assembly. A bottom enclosure may be positioned beneath the insulation layer to retain the insulation and protect internal components. The bottom enclosure may also comprise holes or openings for receipt of the studs.

For precise temperature control, the griddle may be equipped with a temperature controller electrically coupled to the heating element(s). This controller may regulates the heat supplied to the cast aluminum platen, ensuring that the cooking surface maintains the desired temperature. In embodiments designed for multiple temperature zones, the griddle may include a plurality of cast aluminum platens arranged side by side beneath a single steel griddle plate, with each platen configured to be independently controlled by a separate temperature controller and heating element. This configuration may allow for distinct temperature zones with minimal heat bleed between them, enabling cooks to prepare different foods at optimal temperatures simultaneously.

The spring support assembly may comprise a plurality of springs disposed in a grid pattern corresponding to the arrangement of the studs, providing uniform compression across the griddle surface.

The griddle may be adaptable for use in various commercial foodservice applications, including clamshell grills, egg cookers, and tortilla grills. The griddle may also be configured for use with gas or propane heating (e.g., a gas heating element and/or a propane heating element) in addition to electric heating, with the cast aluminum platen serving as a heat sink for different heat sources.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a griddle constructed in accordance with an embodiment of the present disclosure;

FIG. 2 is a top plan view of the griddle, with embedded serpentine heating elements depicted in phantom and defining discrete temperature zones within the griddle;

FIG. 3 is an exploded side view of the griddle of FIGS. 1 and 2, illustrating multiple cast aluminum platens used in connection with a single griddle plate;

FIG. 4 is a cross-sectional assembled front view taken along line 4-4 of FIG. 2;

FIG. 5 is an exploded front view of an alternative embodiment of the griddle including a single cast aluminum platen used in connection with a single gridle plate;

FIG. 6 is an exploded perspective view of the griddle of FIG. 5;

FIG. 7 is a perspective view of the steel griddle plate with threaded studs welded in a grid pattern to its underside;

FIG. 8 is a top plan view of the griddle of FIG. 2 in use, highlighting the multiple temperature zones;

FIG. 9 is a perspective view of a dual-zone griddle;

FIG. 10 is a top plan view of the dual-zone griddle of FIG. 9;

FIG. 11 is a perspective view of a single-zone griddle; and

FIG. 12 is a top plan view of the single-zone griddle of FIG. 11.

Common reference numerals are used throughout the drawings and the detailed description to indicate the same elements.

### DETAILED DESCRIPTION

The detailed description set forth below in connection with the appended drawings is intended as a description of certain embodiments of a griddle and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to a griddle that overcomes the limitations of conventional commercial griddles by combining a cast aluminum heat-sink platen, a thin steel griddle plate, and a spring-loaded compression assembly. The cast aluminum platen features at least one fully encapsulated heating element, ensuring even heat distribution and protecting the heating element from direct exposure to high temperatures. The steel griddle plate, machined for a smooth and level interface, is notably thin to enable rapid and efficient heat transfer. A spring-biased connection between the aluminum platen and steel griddle plate maintains tight contact therebetween to accommodate differential thermal expansion and preventing warping. The griddle may also be configured to implement multiple temperature zones making it particularly well-suited for demanding commercial foodservice applications.

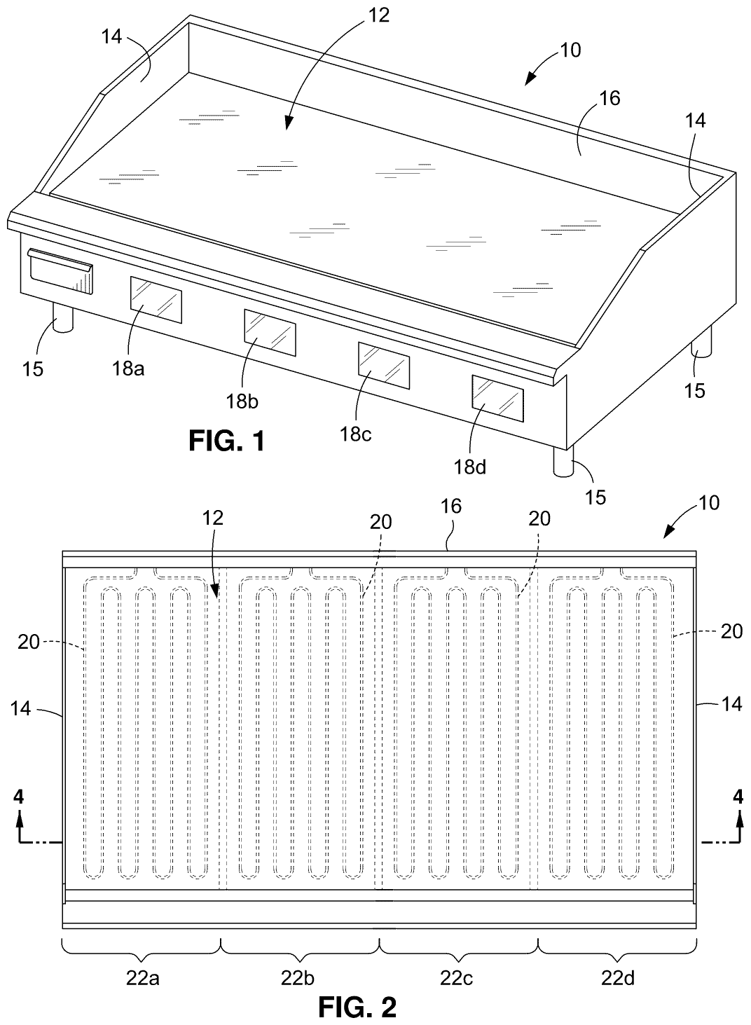

Referring now specifically to the drawings, FIG. 1 illustrates a perspective view of a griddle 10 including a steel griddle plate 12 forming the primary cooking surface, surrounded by raised side and back splashes 14, 16 extending above the steel griddle plate 12 to contain grease and food products. The steel griddle plate 12 is notably thin, which enables rapid heat transfer and faster recovery times, improving cooking performance and energy efficiency. According to one embodiment, the steel griddle plate 12 defines a thickness of less than 0.2 inches, with the thickness being defined as the distance between an upper surface and an opposing lower surface of the steel griddle plate. In other embodiments, the thickness may be slightly greater than 0.2 inches without departing from the spirit and scope of the present disclosure, such as 0.3 inches or 0.4 inches. In any event, it is desirable to maintain a thickness of less than 0.5 inches.

A front of the steel griddle plate 12 is open (e.g., not impeded by a wall) to allow for easy access thereto. A grease trough may extend from one side to the other, in front of the griddle plate 12 to capture grease from the cooking surface.

A control panel includes separate temperature controllers 18a-d is provided for temperature adjustment and operational control of the griddle 10. The inclusion of multiple temperature controllers 18a-d may facilitate separate and independent temperature control over different zones or regions of the cooking surface. Each temperature controller 18a-d may include a user actuatable controller (e.g., knob, dial, slide, touch screen, etc.) that may allow a user to set a temperature, as well as a cook time, and an alarm. The control panel may be in operative communication with one or more temperature sensors and control processors to implement the desired functionalities. In this regard, the temperature sensors may sense the temperature of the cooking surface and send the sensed temperature data to the control processor(s), which may in turn, generate control instructions in accordance with the desired cooking parameters. In this regard, the control processor(s) may implement autonomous cooking control based on the inputs received from the user via the control panel 18. It is noted that while FIG. 1 shows four physically separate controllers 18a-d, other embodiments may integrate all controllers into a single controller that may be capable of enabling a user to toggle or switch between user control of the separate temperature zones.

The griddle 10 may also include four adjustable legs 15 at each corner to enable leveling of the cooking surface.

FIG. 2 depicts a top plan view of the griddle 10 and depicts internal serpentine heating elements 20, which may be encapsulated within respective cast aluminum heat platens, as will be described in more detail below. The arrangement of these heating elements 20 also allows for the creation of distinct temperature zones 22a-d, enabling simultaneous cooking of different foods at optimal temperatures and reducing heat bleed between zones 22a-d.

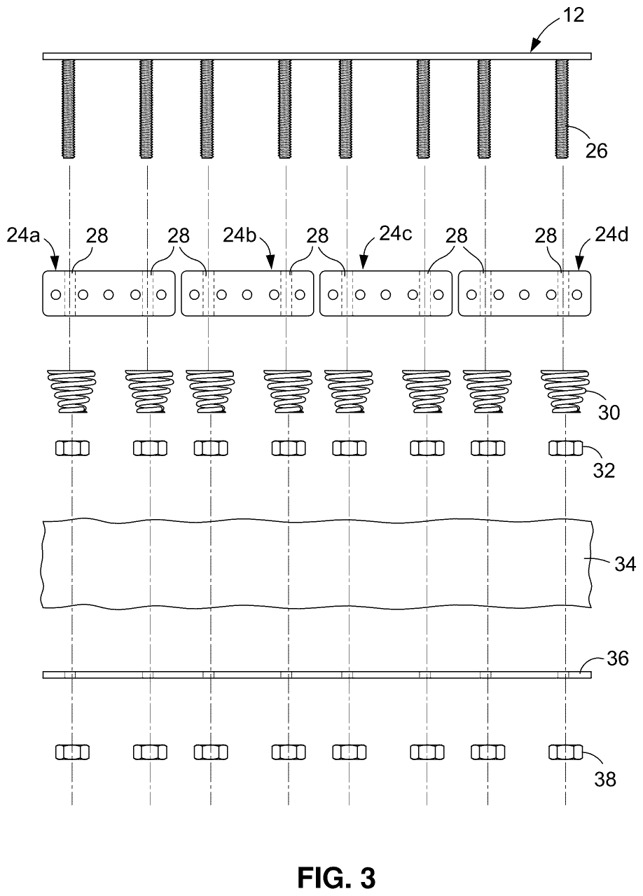

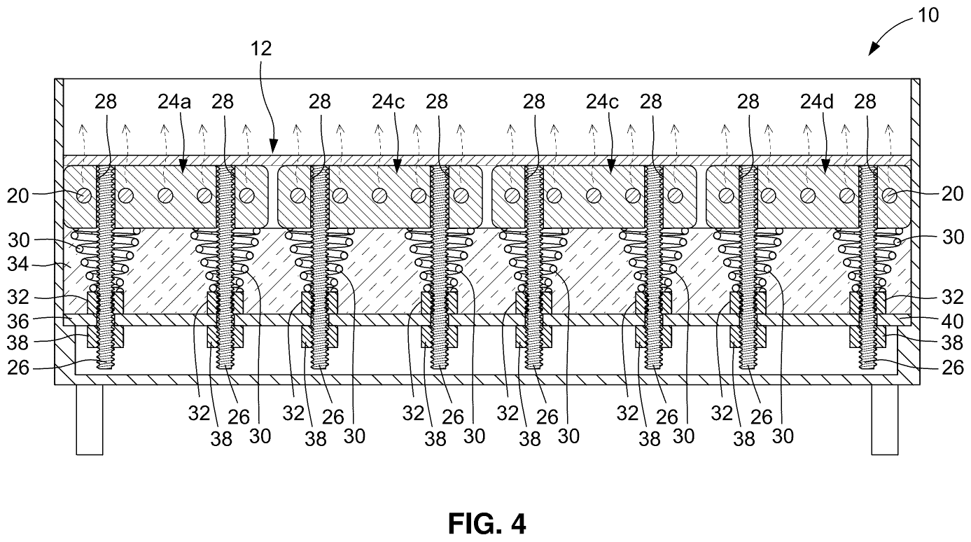

FIG. 3 is a front exploded view of part of the griddle 10, while FIG. 4 presents a cross-sectional front view taken along line 4-4 of FIG. 2 to illustrate the internal components of the griddle 10. In particular, cast aluminum platens 24a-d and the embedded heating elements 20 are shown. In one embodiment, each cast aluminum platen 24 is formed by pouring molten aluminum into a mold with the heating element(s) 20 positioned therein. The high thermal conductivity of aluminum ensures even heat distribution across the platen 24, eliminating hot and cold spots commonly found in traditional steel griddles. As shown in FIG. 4, a bottom surface of the steel griddle plate 12 is positioned directly above and in contact with an upper surface of the cast aluminum platen 24 to allow for optimal heat transfer therebetween. Each aluminum platen 24a-d may be 12-inches wide, while the steel griddle plate may be 48-inches wide. Of course, griddles 10 having different dimensions are contemplated without departing from the spirit and scope of the present disclosure.

According to one embodiment, connection between the steel griddle plate 12 and the cast aluminum platen(s) 24 may be effectuated via a plurality of studs 26 extending from the steel griddle plate 12 that are received within corresponding openings 28 formed in the cast aluminum platens 24a-d. In particular, the studs 26 may be threaded studs 26 that are welded, or otherwise connected, to the bottom surface of the steel griddle plate 12. When the steel griddle plate 12 and cast aluminum platens 24a-d are in proper alignment, the studs 26 are aligned with respective openings 28, such that when the steel griddle plate 12 is lowered onto the cast aluminum platens 24a-d, the studs 26 extend downward through the openings 28. Heavy-duty springs 30 are disposed on each stud 26, positioned between the platens 24a-d and a respective nut 32. The springs 30 may include coil springs, curved spring washers, finger spring washers, wave spring washers, Belleville washers, or other springs known in the art. The nut 32 may be screwed onto the stud 26 to capture and compress the spring 30 between the nut 32 and the respective cast aluminum platen 24. This spring-loaded compression assembly maintains a consistent compressive force, which urges the bottom surface of the cast aluminum platens 24a-d against the upper surface of the steel griddle plate 12. This spring-biased force may counteract forces associated with thermal expansion between the two metals so as to mitigate warping of the steel griddle plate 12. Thus, tight contact may be maintained between the steel griddle plate 12 and the cast aluminum platens 24a-d, which is critical for efficient heat transfer and long-term durability. The spring assembly also protects the integrity of the studs 26, reducing the risk of mechanical failure due to repeated thermal cycling.

Below the platens 24a-d, an insulation layer 34 is provided to minimize heat loss, and a bottom enclosure/plate 36 retains the insulation layer 34 and protects internal components, further enhancing energy efficiency. The insulation layer 34 may extend around the studs 26 and nuts 32, as shown in the embodiment depicted in FIG. 4. The bottom enclosure/plate 36 may be held in place by nuts 38, which may also be connected to the studs 26. In this regard, the bottom enclosure/plate 36 may include openings to allow the studs 26 to pass therethrough, with the bottom enclosure/plate 36 being captured between nuts 32 (e.g., upper nuts) and nuts 38 (e.g., lower nuts). In addition, the bottom enclosure/plate 36 may also be supported by a shoulder 40 formed on a lower portion of a main housing of the griddle 10. In this regard, the collective weight of the griddle plate 12, cast aluminum platen 24, heating elements 20, studs 26, springs 30, nuts 32, 38, insulation layer 34, and bottom enclosure plate 36, as well as any food cooking on the griddle plate 12, may be borne or supported by the shoulder 40.

Alternatively, the insulation layer 34 may reside below the nuts 32 and may be held in place by the nuts 38. In such an embodiment, the insulation layer 34 may be positioned between a first set of nuts 32 positioned above the insulation layer 34, and a second set of nuts 38 positioned below the insulation layer 34.

The configuration of the griddle 10 allows for easy assembly and maintenance, while ensuring tight contact between the steel and aluminum components (e.g., steel griddle plate 12 and cast aluminum platens 24a-d). The modular nature of the griddle 10 also facilitates repair and replacement of individual components, reducing downtime and maintenance costs.

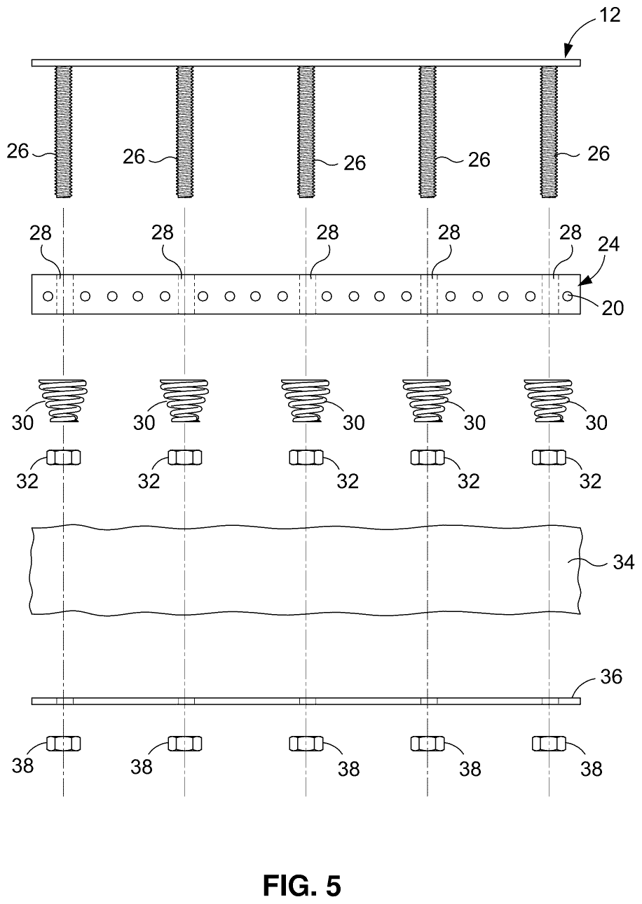

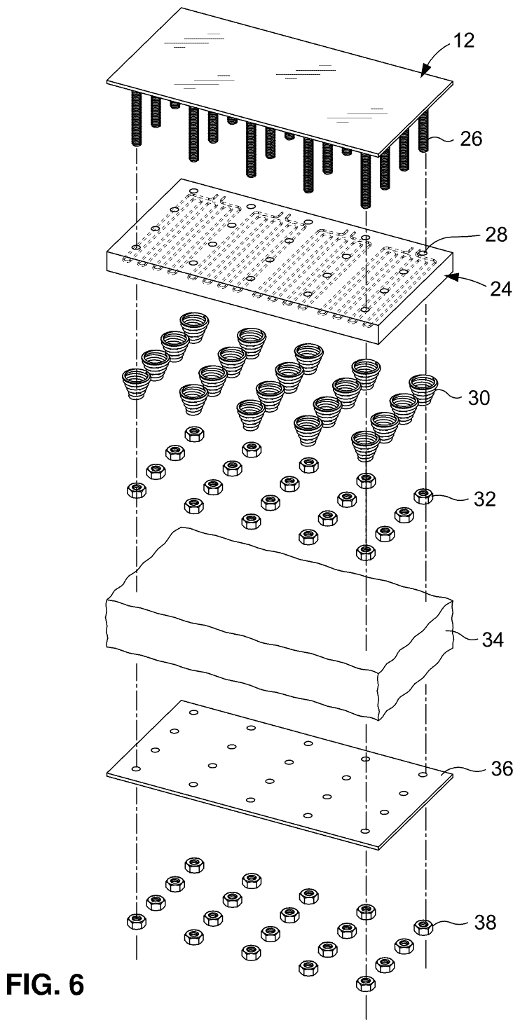

While the above-described embodiment of the griddle 10 includes multiple platens 24a-d, each being associated with a respective temperature zone, it is understood that the scope of the present disclosure is not limited thereto. Along these lines, FIGS. 5 and 6 presents an exploded views of an alternative griddle assembly, wherein a single cast aluminum platens 24 is used with a single griddle plate 12. Several independent heating elements 20 may be embedded within the single cast aluminum platen 24, and may defined separate temperature zones. However, the boundary between adjacent temperature zones may not be as delineated as when each temperature zone is associated with its own, distinct platen 24.

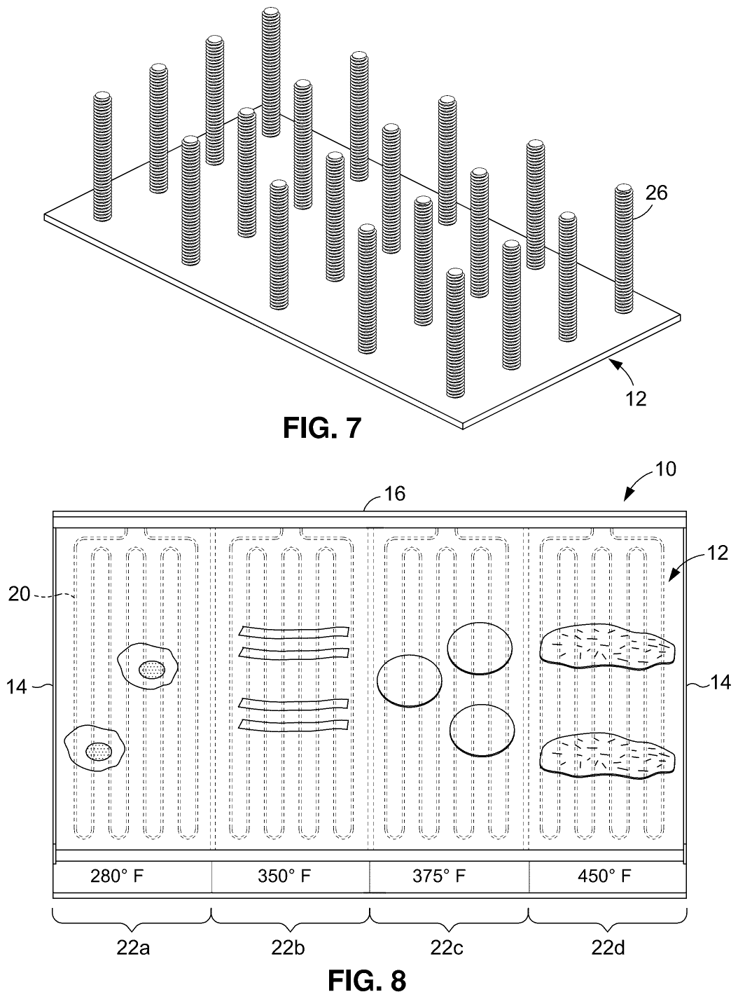

FIG. 7 is a perspective view of the steel griddle plate 12 with threaded studs 26 welded in a grid pattern to its underside. This arrangement ensures that compressive force is evenly distributed throughout the steel griddle plate 12, to mitigate warping and to maintain efficient heat transfer between the steel plate 12 and the cast aluminum platen(s) 24. The use of a thin steel plate 12 atop the aluminum platen(s)/heat sink(s) 24 provides the durability required for commercial use, while maximizing the benefits of aluminum's superior thermal conductivity.

FIG. 8 shows a top plan view of the griddle 10 in use to highlight the multiple temperature zones 22a-d. The placement of embedded heating elements 20 and temperature sensors allows for separate and independent control of each zone 22a-d, minimizing heat bleed and enabling precise cooking conditions for various food items. This feature is particularly advantageous in commercial kitchens, where different foods require different cooking temperatures and consistency is paramount.

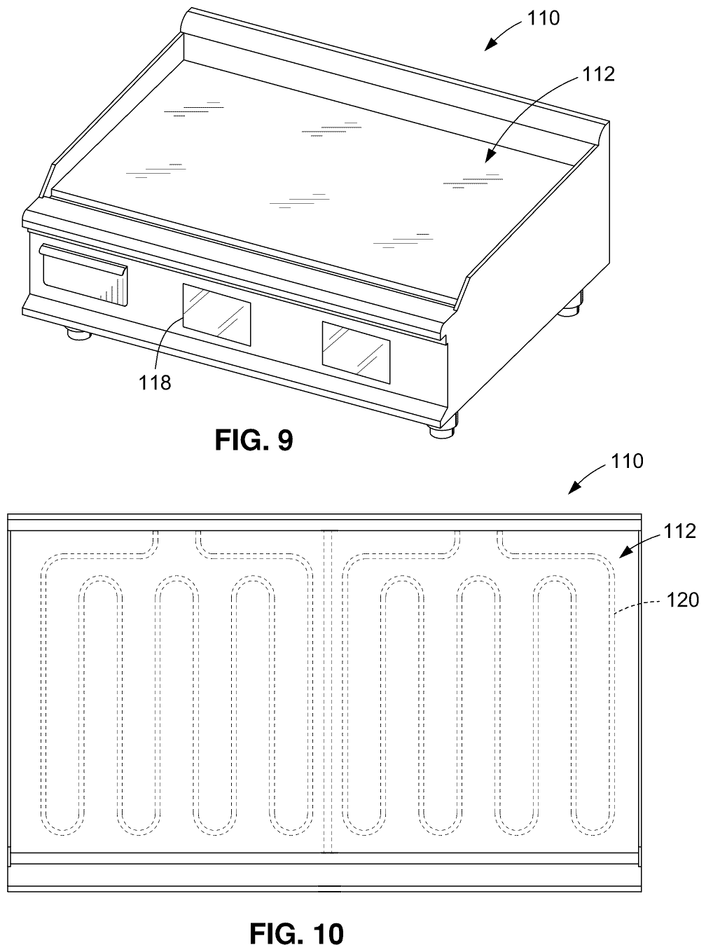

FIG. 9 depicts a perspective view of a dual-zone griddle 110. This embodiment features a steel griddle plate 112, a pair of cast aluminum platen, s and a control panel 118 for temperature regulation. The compact design is suitable for smaller commercial applications or specialized cooking tasks, while still providing the advantages of improved heat transfer, energy efficiency, and durability. FIG. 10 shows a top plan view of the griddle 110 for the dual-zone griddle 110, with a pair of serpentine heating elements 120 embedded within the platen to ensure uniform heat distribution.

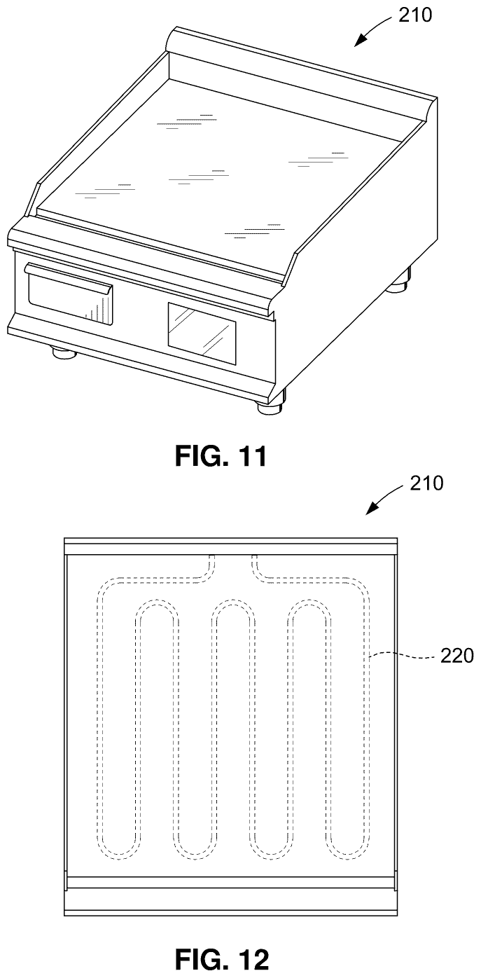

FIG. 11 illustrates a perspective view of a compact, single-zone griddle 210, optimized for space-saving and portability. FIG. 12 provides a top plan view of the compact griddle 210, showing the embedded heating element 220. The design ensures that heat is efficiently transferred to the cooking surface, while minimizing energy loss to the environment.

As can be seen in the various embodiments, any number of heating elements may be incorporated into the griddle to achieve desired dimensions, heating zones, etc., depending on the intended use of the griddle.

In operation, the griddle delivers improved thermal conductivity, energy efficiency, and temperature consistency compared to traditional designs. The encapsulated heating elements are protected from direct exposure, reducing the risk of element failure. The spring-loaded compression assembly maintains tight contact between the cast aluminum platen and steel griddle plate, accommodating thermal expansion and contraction while preventing warping and ensuring efficient heat transfer. The griddle may be configured for use with gas or propane heating elements in addition to, as or as substitute to electric heating, with the cast aluminum platen serving as a heat sink for various heat sources. The griddle is adapted for use in commercial foodservice applications, including clamshell grills, egg cookers, and tortilla grills.

The present disclosure provides significant advantages over conventional griddle technology, including improved temperature consistency, enhanced energy efficiency, reduced maintenance and downtime, extended heating element life, and the ability to maintain sharply defined temperature zones. These benefits make the griddle particularly well-suited for demanding commercial environments where performance, reliability, and versatility are essential.

It will be understood that the invention is not limited to the specific embodiments described and illustrated herein, and that modifications and variations may be made without departing from the spirit and scope of the invention as defined by the appended claims.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A griddle comprising:
a cast aluminum platen having a top surface, a bottom surface, and at least one opening;
at least one heating element having a portion fully encapsulated within the cast aluminum platen;
a steel griddle plate having a bottom surface abutting the top surface of the cast aluminum platen;
at least one stud coupled to the bottom surface of the steel griddle plate and extending through a corresponding one of the at least one opening in the cast aluminum platen;
a spring disposed on a corresponding one of the at least one stud; and
a spring support adapted to support the spring, the spring support configured to urge the cast aluminum platen against the steel griddle plate to accommodate differential thermal expansion between the cast aluminum platen and the steel griddle plate.

2. The griddle recited in claim 1, wherein the steel griddle plate defines a thickness of less than 0.2 inch.

3. The griddle recited in claim 1, further comprising a temperature controller electrically coupled to the heating element and configured to regulate heat supplied to the cast aluminum heat-sink platen.

4. The griddle of claim 1, wherein the heating element is a tubular heating element bent in a serpentine fashion within the cast aluminum platen.

5. The griddle of claim 1, wherein the cast aluminum platen is formed by pouring molten aluminum into a mold with the heating element positioned therein.

6. The griddle of claim 1, wherein the spring is a coiled compression spring.

7. The griddle of claim 1, wherein the spring is a spring washer.

8. The griddle of claim 1, wherein the stud is a threaded steel stud welded to the bottom surface of the steel griddle plate.

9. The griddle of claim 1, wherein the spring support is a nut disposed on the stud to secure the spring and provide adjustable compression.

10. The griddle of claim 1, further comprising an insulation layer disposed below the cast aluminum platen.

11. The griddle of claim 10, wherein the insulation layer defines holes corresponding to the location of the studs.

12. The griddle of claim 10, further comprising a bottom enclosure disposed below the insulation layer.

13. The griddle of claim 12, wherein the bottom enclosure defines holes corresponding to the location of the studs.

14. The griddle of claim 1, wherein the cast aluminum platen comprises a plurality of platens arranged to define distinct temperature zones.

15. The griddle of claim 14, wherein each cast aluminum platen is independently controlled by a separate temperature controller.

16. The griddle of claim 1, wherein the heating element is fully encapsulated within the cast aluminum platen except for electrical leads extending from the cast aluminum platen.

17. A griddle comprising:
a cast aluminum heat-sink platen having a top surface and a bottom surface, the cast aluminum heat-sink platen defining a plurality of openings;
a steel griddle plate positioned above and in direct contact with the top surface of the cast aluminum heat-sink platen, the steel griddle plate having a thickness less than 0.2 inch;
a plurality of heating elements, each heating element being fully encapsulated within a corresponding cast aluminum heat-sink platen except for electrical leads extending from the platen;
a plurality of threaded studs affixed to the bottom surface of the steel griddle plate and extending through the plurality of openings in the cast aluminum heat-sink platen;
a plurality of springs disposed on the plurality of threaded studs, each spring being supported by a spring support configured to urge the cast aluminum heat-sink platen against the steel griddle plate and accommodate differential thermal expansion between the cast aluminum heat-sink platen and the steel griddle plate;
an insulation layer disposed below the cast aluminum heat-sink platen and defining oversized holes corresponding to the location of the threaded studs.

18. The griddle recited in claim 17, further comprising a temperature controller electrically coupled to each heating element and configured to independently regulate heat supplied to each cast aluminum heat-sink platen.

19. The griddle of claim 17, wherein the spring is a coiled compression spring.

20. The griddle of claim 17, wherein each stud is a threaded steel stud welded to the bottom surface of the steel griddle plate.
